(19) United States
(12) Patent Application Publication
(10) Pub. No.: US 2015/0032904 A1
(43) Pub. Date: Jan. 29, 2015

(54) Non-Stop Routing of Routing Protocol

(71) Applicant: Hangzhou H3C Technologies Co., Ltd., Hangzhou, Zhejiang (CN)

(72) Inventor: Haifeng Zhang, Haidian District (CN)

(21) Appl. No.: 14/373,891

(22) PCT Filed: Jul. 9, 2013
(86) PCT No.: PCT/CN2013/079032

§ 371 Date: Jul. 22, 2014

(30) Foreign Application Priority Data
Jul. 25, 2012 (CN) 201210259526.2

(51) Int. Cl. H04L 12/775; H04L 12/723; H04L 12/741

(52) U.S. Cl. CPC H04L 45/58; H04L 45/54; H04L 45/50; H04L 45/745
USPC 709/238

(57) ABSTRACT

A method is provided for a router to implement non-stop routing of a routing protocol. The router has primary and backup routing engines or a single routing engine. When the primary routing engine or the only routing engine is operating normally, neighbor state information is backed up to the backup routing engine or a nonvolatile memory in the router. After the backup routing engine takes over for the primary routing engine or the single routing engine reboots, the backup routing engine or the single routing engine maintains neighbor relationships based on the neighbor state information, obtains routing information based on the saved neighbor state information. The backup routing engine or the single routing engine then generates local routes based on the routing information, determines best routes based on the local routes, sends the best routes to the neighboring routers, and saves the best routes to local hardware.

### BACKGROUND

Non-stop routing (NSR) is a feature that provides continuous packet forwarding in routers. NSR is easy to deploy as a router can use NSR without any need to configure its peers.

### BRIEF DESCRIPTION OF THE DRAWINGS

In the drawings:

FIG. 1 is a block diagram of a computer network including a router having primary and backup routing engines to implement non-stop routing (NSR) in one or more examples of the present disclosure;

FIG. 2 is a flowchart of a method for the router of FIG. 1 to implement NSR in one or more examples of the present disclosure;

FIG. 3 is a flowchart of a method for the NSR router in FIG. 1 to implement NSR of the Border Gateway Protocol (BGP) routing protocol in one or more examples of the present disclosure;

FIG. 4 is a flowchart of a method for the NSR router in FIG. 1 to implement NSR of the Intermediate System-Intermediate System (IS-IS) routing protocol when the NSR router is a Designated Intermediate System (DIS) in a broadcast network in one or more examples of the present disclosure;

FIG. 5 is a flowchart of a method for the NSR router in FIG. 1 to implement NSR of the IS-IS routing protocol when the NSR router is not a DIS in a broadcast network in one or more examples of the present disclosure;

FIG. 6 is a flowchart of a method for the NSR router in FIG. 1 to implement NSR of the IS-IS routing protocol when the NSR router is in a point-to-point (P2P) network in one or more examples of the present disclosure;

FIG. 7 is a flowchart of a method for the NSR router in FIG. 1 to implement NSR of the Open Shortest Path First (OSPF) routing protocol in one or more examples of the present disclosure;

FIG. 8 is a flowchart of a method for the NSR router in FIG. 1 to implement NSR of the Label Distribution Protocol (LDP) routing protocol in one or more examples of the present disclosure;

FIG. 9 is a block diagram of the NSR router in FIG. 1 in one or more examples of the present disclosure;

FIG. 10 is a block diagram of a route processor in the NSR router of FIG. 9 in one or more examples of the present disclosure;

FIG. 11 is a flowchart of a method for a router having a single routing engine to implement NSR in one or more examples of the present disclosure; and

FIG. 12 is a block diagram of a NSR router having a single routing engine in one or more examples of the present disclosure.

Use of the same reference numbers in different figures indicates similar or identical elements.

### DETAILED DESCRIPTION

As used herein, the term “includes” means includes but not limited to, the term “including” means including but not limited to. The terms “a” and “an” are intended to denote at least one of a particular element. The term “based on” means based at least in part on.

A router with non-stop routing (NSR) is implemented with a primary routing engine and a backup routing engine. The backup routing engine is completely synchronized with the primary routing engine so the backup routing engine can take over for the primary routing engine after the primary routing engine experiences a fault. To synchronize the routing engines, the primary routing engine backs up neighbor state information and routing information for its routing protocol when the primary routing engine is operating normally. As a computer network increases in size so do routing tables at routers, which makes it complicated to maintain synchronization between the primary and the backup routing engines. Additionally more system resources are spent maintaining synchronization, which slows down the processing of other software services.

In some examples of the present disclosure, a router implements NSR of a routing protocol. The router has a primary routing engine and a backup routing engine. When the primary routing engine is operating normally, it backs up neighbor state information to backup routing engine. When the backup routing engine takes over for the primary routing engine, the backup routing engine obtains routing information based on the neighbor state information at the backup routing engine. The backup routing engine then generates local routes based on the routing information, determines best routes based on the local routes, sends the best routes to neighboring routers, and saves the best routes to local hardware. The router in this example may thus provide the NSR functionality, but simplify the synchronization between primary and backup routing engines.

In other examples of the present disclosure, a router that implements NSR of a routing protocol has a single routing engine. When the routing engine is operating normally, it backs up neighbor state information to a nonvolatile memory. After the routing engine reboots, the routing engine obtains the routing information based on the neighbor state information saved in the nonvolatile memory. The routing engine then generates local routes based on the routing information, determines best routes based on the local routes, sends the best routes to neighboring devices, and saves the best routes to local hardware. The router in this example may thus provide the NSR functionality, but without requiring primary and backup routing engines.

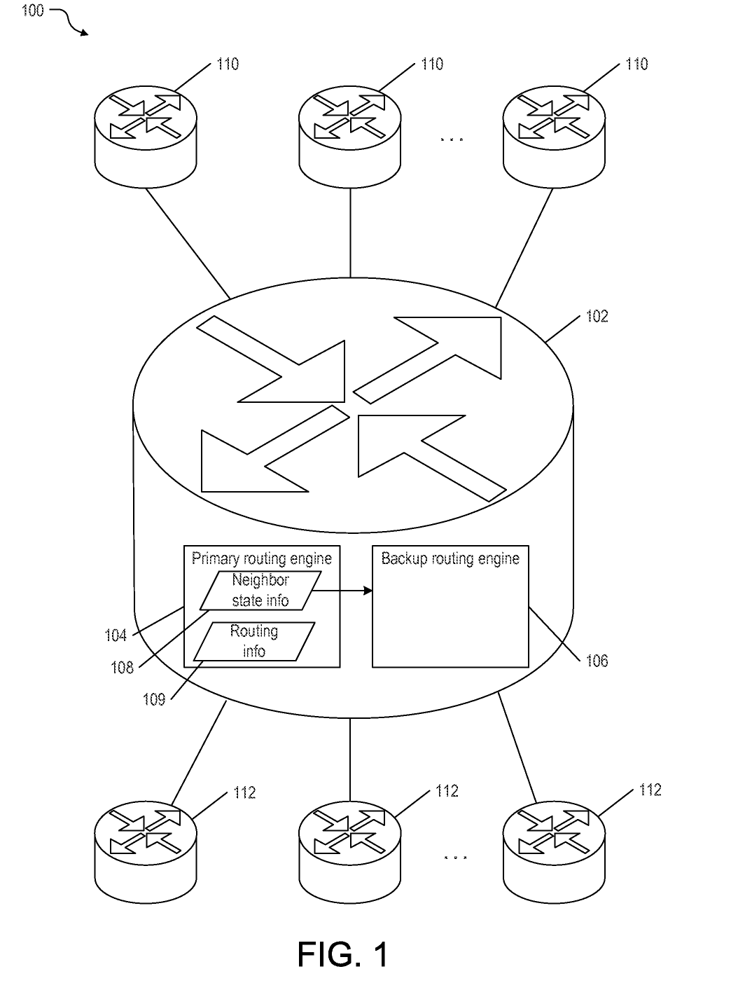

FIG. 1 is a block diagram of a computer network 100 in one or more examples of the present disclosure. Network 100 includes a routing device or router 102 that implements NSR of a routing protocol. Examples of the routing protocol include Border Gateway Protocol (BGP), Intermediate System-Intermediate System (IS-IS), Open Shortest Path First (OSPF), and Label Distribution Protocol (LDP). Router 102 includes a primary routing engine 104 and a backup routing engine 106. When primary routing engine 104 is operating normally, it backs up neighbor state information 108 but not routing information 109 to backup routing engine 106. Neighbor state information 108 may include IDs and interface addresses of neighboring routers. Routing information 109 may include network destination, netmask, interface, and next hop. Router 102 may be connected to two or more neighboring routing devices or routers 110 and 112. Neighboring routers 110 may be upstream from router 102, and neighboring routers 112 may be downstream from router 102.

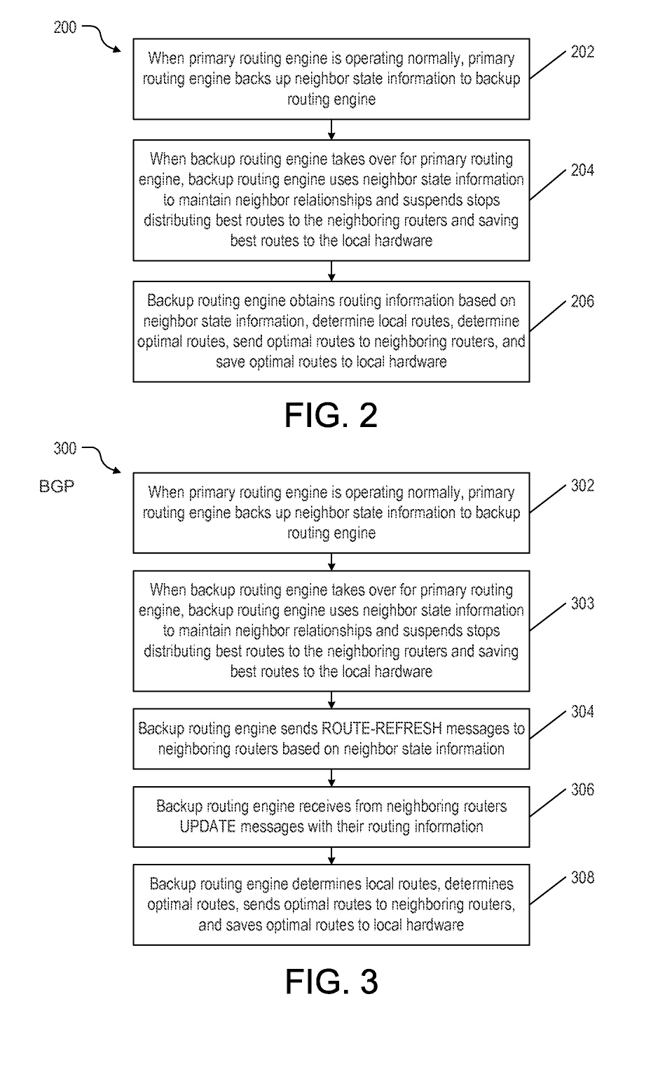

FIG. 2 is a flowchart of a method 200 for router 102 (FIG. 1) to implement NSR of a routing protocol in one or more examples of the present disclosure. Any method described herein may include one or more operations, functions, or actions illustrated by one or more blocks. Although the blocks are illustrated in sequential orders, these blocks may also be performed in parallel, and/or in a different order than those described herein. Also, the various blocks may be combined into fewer blocks, divided into additional blocks, and/or eliminated based upon the desired implementation. Method 200 may begin in block 202.

In block 202, when primary routing engine 104 (FIG. 1) is operating normally, it backs up neighbor state information 108 (FIG. 1) but not routing information 109 (FIG. 1) to backup routing engine 106 (FIG. 1). Block 202 may be followed by block 204.

In block 204, when backup routing engine 106 takes over for primary routing engine 104 in a switchover, the backup routing engine uses neighbor state information 108 to maintain neighbor relationships (e.g., continue to send hello packets to neighbor routers) to ensure neighbor connections of the routing protocol are not interrupted after the switchover. Backup routing engine 106 also suspends (e.g., stops) distributing (e.g., advertising) best routes to the neighboring routers and saving the best routes to the local hardware until the best routes are determined again. Block 204 may be followed by block 206.

In block 206, backup routing engine 106 obtains routing information 109 based on neighbor state information 108. The switchover may be unplanned, such as when primary routing engine 104 has a fault. In another example the switchover may be planned, such as when primary routing engine 104 updates its firmware. The details of how backup routing engine 106 uses neighbor state information 108 to obtain routing information 109 are described later for various routing protocols as well as some network types. Note that router 102 may handle one, several, or all of the routing protocols described later.

After obtaining routing information 109, backup routing engine 106 determines local or self-originated routes based on the routing information, determines best routes based on the local routes, sends the best routes to neighboring routers 110 and 112, and saves the best routes to local hardware, such as a forwarding chip. Local routes are routes that are locally generated by backup routing engine 106.

### BGP Routing Protocol

FIG. 3 is a flowchart of an example method 300, which may be used to implement NSR by the BGP routing protocol. Method 300 may begin in block 302.

In block 302, when primary routing engine 104 (FIG. 1) is operating normally, the primary routing engine backs up neighbor state information 108 (FIG. 1) but no routing information 109 (FIG. 1) to backup routing engine 106 (FIG. 1). Block 302 may be followed by block 303.

In block 303, when backup routing engine 106 takes over for primary routing engine 104 in a switchover, the backup routing engine uses neighbor state information 108 to maintain neighbor relationships to ensure neighbor connections of the routing protocol are not interrupted after the switchover. Backup routing engine 106 also suspends distributing best routes to the neighboring routers and saving the best routes to the local hardware until the best routes are determined again. Block 303 may be followed by block 304.

In block 304, backup routing engine 106 sends a ROUTE-REFRESH message to neighboring routers 110 and 112 (FIG. 1) based on neighbor state information 108. In other words, backup routing engine 106 uses neighbor state information 108 to determine where to send the ROUTE-REFRESH messages. Block 304 may be followed by block 306.

In block 306, backup routing engine 106 receives from neighboring routers 110 and 112 UPDATE messages with their routing information. Note that through blocks 304 and 306, backup routing engine 106 has obtained routing information 109 based on neighbor state information 108. Block 306 may be followed by block 308.

In block 308, backup routing engine 106 determines local routes based on the routing information in the UPDATE messages from neighboring routers 110 and 112, determines best routes based on the local routes and routes received from neighboring routers 110 and 112, sends the best routes to neighboring routers 110 and 112, and saves the best routes to local hardware.

### IS-IS Routing Protocol—DIS in Broadcast Network

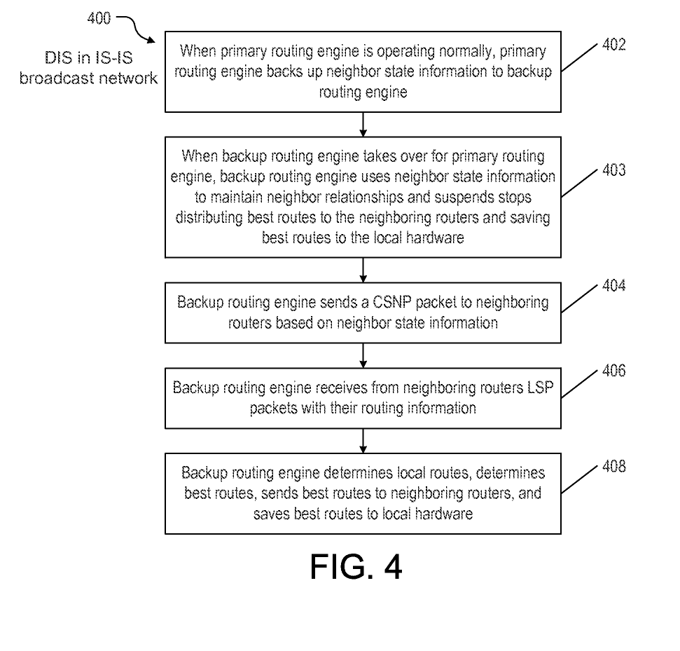

FIG. 4 is a flowchart of an example method 400, which may be used to implement NSR by the IS-IS routing protocol. In this example, router 102 may be a Designated Intermediate System (DIS) in a broadcast network 100 (FIG. 1).

In a broadcast network, a network segment has one DIS that periodically broadcasts a Complete Serial Number Protocol data unit (CSNP) packet. The CSNP packet summarizes Link-State Protocol data units (LSPs) in the DIS's link-state database (LSDB). More specifically, the CSNP packet includes headers of the LSPs in the DIS's LSDB. When a router receives the CSNP packet, it compares the LSPs in its LSDB against the summary of the LSPs in the DIS's LSDB to determine if it is missing any LSPs.

When the router determines that the CSNP is missing certain LSPs found in its LSDB, it sends a LSP packet with the missing LSPs to the DIS. In response, the DIS updates its LSDB with the missing LSPs.

When the router determines it is missing certain LSPs found in the CSNP, it sends a Partial Sequence Number Protocol data unit (PSNP) packet to the DIS. The PSNP packet includes a summary of the missing LSPs. More specifically, the PSNP packet includes headers of the missing LSPs. In response, the DIS sends a LSP packet with the missing LSPs to the router, and the router updates its LSDB with the missing LSPs.

Method 400 may begin in block 402. In block 402, when primary routing engine 104 (FIG. 1) is operating normally, the primary routing engine backs up neighbor state information 108 (FIG. 1) but not routing information 109 (FIG. 1) to backup routing engine 106 (FIG. 1). Block 402 may be followed by block 403.

In block 403, when backup routing engine 106 takes over for primary routing engine 104 in a switchover, the backup routing engine uses neighbor state information 108 to maintain neighbor relationships to ensure neighbor connections of the routing protocol are not interrupted after the switchover. Backup routing engine 106 also suspends distributing best routes to the neighboring routers and saving the best routes to the local hardware until the best routes are determined again. Block 403 may be followed by block 404.

In block 404, backup routing engine 106 send a CSNP packet to neighboring routers 110 and 112 (FIG. 1) based on neighbor state information 108. Backup routing engine 106 may use neighbor state information 108 to determine where to send the CSNP packet. The CSNP packet carries a summary of routing information available at backup routing engine 106 (e.g., headers of LSPs in the backup routing engine's LSDB), which is empty as the backup routing engine does not have any routing information at this time. Block 404 may be followed by block 406.

In block 406, backup routing engine 106 receives an LSP packet from each neighboring router that has identified routing information that exists at the neighboring router (one or more LSPs found in its LSDB) but is not described in the CSNP packet. The LSP packet includes the missing routing information (the one or more missing LSPs). Backup routing engine 106 updates its LSDB with the missing routing information (the missing LSPs). Note that through blocks 404 and 406, backup routing engine 106 has obtained routing information 109 based on neighbor state information 108. Block 406 may be followed by block 408.

In block 408, backup routing engine 106 determines local routes based on the routing information in its LSDB, determines best routes based on the local routes and the IS-IS routing protocol, sends the best routes to neighboring routers 110 and 112, and saves the best routes to local hardware.

### IS-IS Routing Protocol—Non-DIS in Broadcast Network

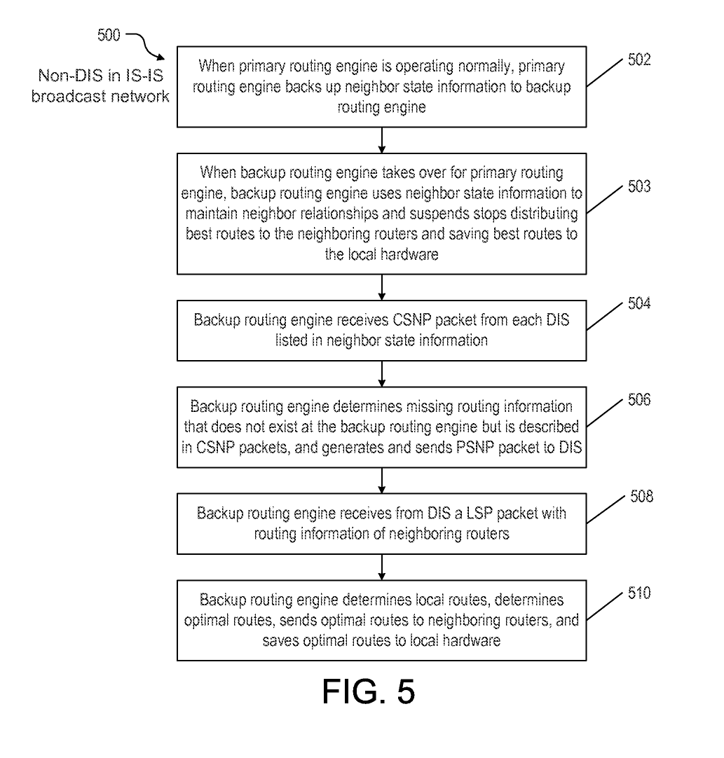

FIG. 5 is a flowchart of an example method 500, which may be used to implement NSR by the IS-IS routing protocol. In these examples, router 102 may be a non-DIS device in a broadcast network 100 (FIG. 1). Router 102 may be located in multiple network segments and communicate with multiple DISs, and neighbor state information 108 (FIG. 1) may further identify the neighboring routers that are DISs.

Method 500 may begin in block 502. In block 502, when primary routing engine 104 (FIG. 1) is operating normally, the primary routing engine backs up neighbor state information 108 but not routing information 109 (FIG. 1) to backup routing engine 106 (FIG. 1). Block 502 may be followed by block 503.

In block 503, when backup routing engine 106 takes over for primary routing engine 104 in a switchover, the backup routing engine uses neighbor state information 108 to maintain neighbor relationships to ensure neighbor connections of the routing protocol are not interrupted after the switchover. Backup routing engine 106 also suspends distributing best routes to the neighboring routers and saving the best routes to the local hardware until the best routes are determined again. Block 503 may be followed by block 504.

In block 504, backup routing engine 106 waits to receive a CSNP packet from each DIS listed in neighbor state information 108. Once backup routing engine 106 receives a CSNP packet from each DIS listed in neighbor state information 108, block 504 may be followed by block 506.

In block 506, backup routing engine 106 determines missing routing information (missing LSPs) that does not exist at the backup routing engine but is described in the summaries of routing information in the CSNP packets. To determine the missing routing information, backup routing engine 106 may compare the summary of routing information in each CSNP packet to routing information available at the backup routing engine (e.g., LSPs in the backup routing engine's LSDB). Backup routing engine 106 then generates a PSNP packet that carries a summary of the missing routing information, which is empty as the backup routing engine does not have any routing information at this time, and sends the PSNP to the corresponding DIS. Block 506 may be followed by block 508.

In block 508, backup routing engine 106 receives a LSP packet with the missing routing information (the missing LSPs) from each DIS. Backup routing engine 106 updates its LSDB with the missing routing information (the missing LSPs). Note that through blocks 506 and 508, backup routing engine 106 has obtained routing information 109 based on neighbor state information 108. Block 508 may be followed by block 510.

In block 510, backup routing engine 106 determines local routes based on the routing information in its LSDB, determines best routes based on the local routes and the IS-IS routing protocol, sends the best routes to neighboring routers 110 and 112, and saves the best routes to local hardware.

IS-IS Routing Protocol—P2P network

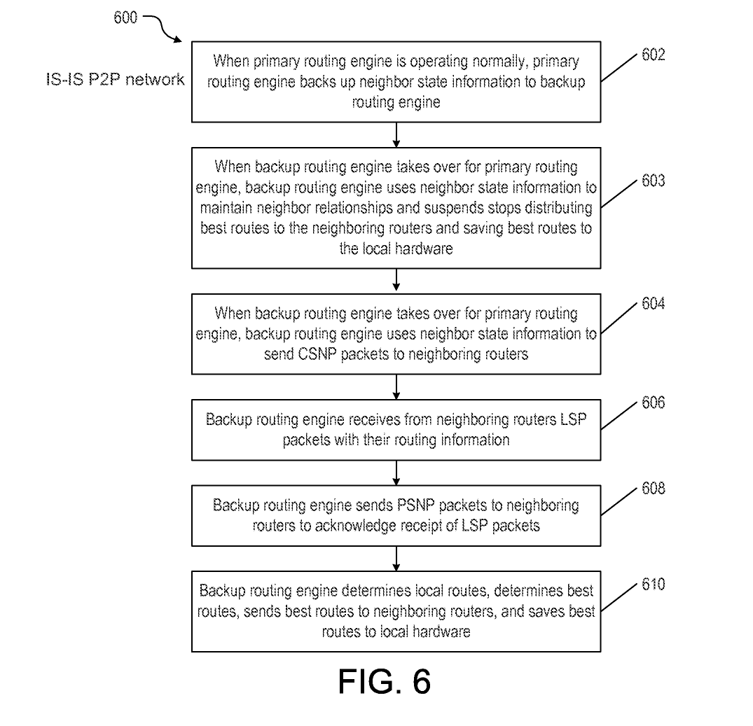

FIG. 6 is a flowchart of an example method 600, which may be used to implement NSR by the IS-IS routing protocol. In this example, router 102 may be in a point-to-point (P2P) network 100 (FIG. 1). In a P2P network, after establishing adjacency with the neighbor relationship, a router sends a CSNP packet to a neighboring router to obtain routing information from the neighboring router.

Method 600 may begin in block 602. In block 602, when primary routing engine 104 (FIG. 1) is operating normally, the primary routing engine backs up neighbor state information 108 (FIG. 1) but not routing information 109 (FIG. 1) to backup routing engine 106 (FIG. 1). Block 602 may be followed by block 603.

In block 603, when backup routing engine 106 takes over for primary routing engine 104 in a switchover, the backup routing engine uses neighbor state information 108 to maintain neighbor relationships to ensure neighbor connections of the routing protocol are not interrupted after the switchover. Backup routing engine 106 also suspends distributing best routes to the neighboring routers and saving the best routes to the local hardware until the best routes are determined again. Block 603 may be followed by block 604.

In block 604, backup routing engine 106 sends a CSNP packet to neighboring routers 110 and 112 (FIG. 1) based on neighboring state information 108. In other words, backup routing engine 106 uses neighbor state information 108 to determine where to send the CSNP packet. The CSNP packet carries a summary of routing information available at backup routing engine 106 (e.g., headers of LSPs in the backup routing engine's LSDB), which is empty as the backup routing engine does not have any routing information at this time. Backup routing engine 106 may send the CSNP packet once. Block 604 may be followed by block 606.

In block 606, backup routing engine 106 receives a LSP packet from each neighboring router that has identified missing routing information that exists at the neighboring router (one or more LSPs found in its LSDB) but is not described in the CSNP packet. The LSP packet includes the missing routing information (the one or more missing LSPs). Backup routing engine 106 updates its LSDB with the missing routing information (the missing LSPs).

Note that through blocks 604 and 606, backup routing engine 106 has obtained routing information 109 based on neighbor state information 108. Block 606 may be followed by block 608.

In block 608, backup routing engine 106 sends one or more PSNP packets to acknowledge receipt of one or more LSP packets from neighboring routers 110 and 112. Block 608 may be followed by block 610.

In block 610, backup routing engine 106 determines local routes based on the routing information in its LSDB, determines best routes based on the local routes and the IS-IS routing protocol, sends the best routes to neighboring routers 110 and 112, and saves the best routes to local hardware.

### OSPF Routing Protocol

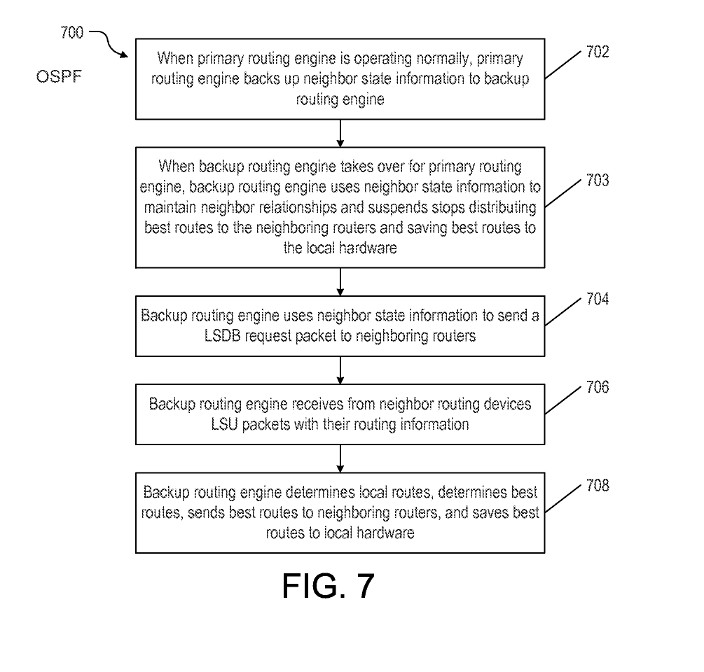

FIG. 7 is a flowchart of an example method 700, which may be used to implement NSR by the OSPF routing protocol. Method 700 may begin in block 702.

In block 702, when primary routing engine 104 (FIG. 1) is operating normally, the primary routing engine backs up neighbor state information 108 (FIG. 1) but not routing information 109 (FIG. 1) to backup routing engine 106 (FIG. 1). Block 702 may be followed by block 703.

In block 703, when backup routing engine 106 takes over for primary routing engine 104 in a switchover, the backup routing engine uses neighbor state information 108 to maintain neighbor relationships to ensure neighbor connections of the routing protocol are not interrupted after the switchover. Backup routing engine 106 also suspends distributing best routes to the neighboring routers and saving the best routes to the local hardware until the best routes are determined again. Block 703 may be followed by block 704.

In block 704, backup routing engine 106 sends a Link State DataBase (LSDB) request packet to neighboring routers 110 and 112 (FIG. 1) based on neighbor state information 108. In other words, backup routing engine 106 uses neighbor state information 108 to determine where to send the LSDB request packet. In response to the LSDB request packet, neighboring routers 110 and 112 returns Link State Update (LSU) packets with the routing information in their LSDBs. Block 704 may be followed by block 706.

In block 706, backup routing engine 106 receives from neighboring routers 110 and 112 LSU packets with the routing information in their LSDBs. Note that through blocks 704 and 706, backup routing engine 106 has obtained routing information 109 based on neighbor state information 108. Block 706 may be followed by block 708.

In block 708, backup routing engine 106 determines local routes based on the routing information from neighboring routers 110 and 112, determines best routes based on the local routes and the OSPF routing protocol, sends the best routes to neighboring routers 110 and 112, and saves the best routes to local hardware.

### LDP

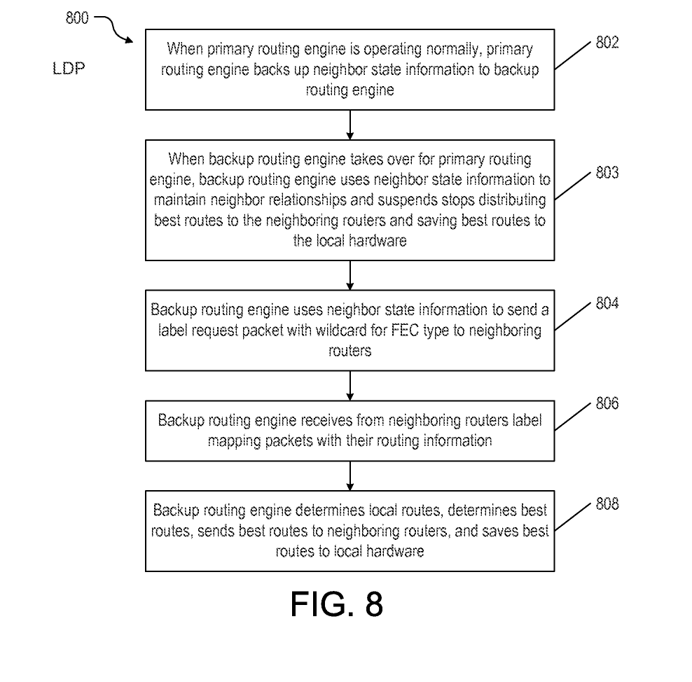

FIG. 8 is a flowchart of a method 800 for router 102 (FIG. 1) to implement NSR of the LDP routing protocol in one or more examples of the present disclosure. In these examples, router 102 may be in a Multi-Protocol Label Switching (MPLS) network 100 (FIG. 1), and routers 110 and 112 (FIG. 1) may be Label Switching Routers (LSRs) having Forwarding Equivalence Classes (FECs). An FEC describes a set of packets with similar or identical characteristics that may be forwarded the same way by binding them to a label. For example, an FEC may be a prefix in the destination Internet Protocol (IP) address.

In a MPLS having two LSRs in the same FEC, the upstream LSR sends a label request packet to a downstream LSR to bind a label to the FEC. The label request packet includes FEC information, which is specified by type, length, and value. In response to the label request packet, the downstream LSR binds a label to the FEC and sends a label mapping packet carrying the FEC and label mapping to the upstream LSR. Based on FEC and label mappings from downstream LSRs, the upstream LSR establishes a label mapping table and forwards packets based on the label mapping table.

Two neighboring LSRs (e.g., LSR1 and LSR2) may belong to multiple FECs (e.g., FEC1, FEC2, and FEC3). For some FECs (e.g., FEC1 and FEC2), LSR1 may be upstream and LSR2 may be downstream. For another FEC (e.g., FEC3), LSR1 may be downstream and LSR2 may be upstream. In a label request packet, a wildcard may be used for the FEC type. In response, a downstream LSR would bind labels to all FECs it knows. For example, if LSR1 sends a label request packet to LSR2 and a wildcard is used for the FEC type, then LSR2 would bind LSR1 to labels associated to FEC1 and to labels associated with FEC2.

Method 800 may begin in block 802. In block 802, when primary routing engine 104 (FIG. 1) is operating normally, the primary routing engine backs up neighbor state information 108 (FIG. 1) but not routing information 109 (FIG. 1) to backup routing engine 106 (FIG. 1). Block 802 may be followed by block 803.

In block 803, when backup routing engine 106 takes over for primary routing engine 104 in a switchover, the backup routing engine uses neighbor state information 108 to maintain neighbor relationships to ensure neighbor connections of the routing protocol are not interrupted after the switchover. Backup routing engine 106 also suspends distributing best routes to the neighboring routers and saving the best routes to the local hardware until the best routes are determined again. Block 803 may be followed by block 804.

In block 804, backup routing engine 106 sends a label request packet to neighboring routers 110 and 112 (FIG. 1) based on neighbor state information 108. In other words, backup routing engine 106 uses neighbor state information 108 to determine where to send the label request packet. The label request packet includes a wildcard for the FEC type. Block 804 may be followed by block 806.

In block 806, backup routing engine 106 receives from neighboring routers 110 and 112 label mapping packets carrying FEC and label mappings (their routing information). Note that through blocks 804 and 806, backup routing engine 106 has obtained routing information 109 based on neighbor state information 108. Block 806 may be followed by block 808.

In block 808, backup routing engine 106 determines local routes based on the routing information from neighboring routers 110 and 112, determines best routes based on the local routes and the OSPF routing protocol, sends the best routes to neighboring routers 110 and 112, and saves the best routes to local hardware. For example, backup routing engine 106 generates a label mapping table based on the FEC and label mappings in the label mapping packets from neighboring routers 110 and 112, sends the label mapping table to the neighboring routers, and save the label mapping table to local hardware.

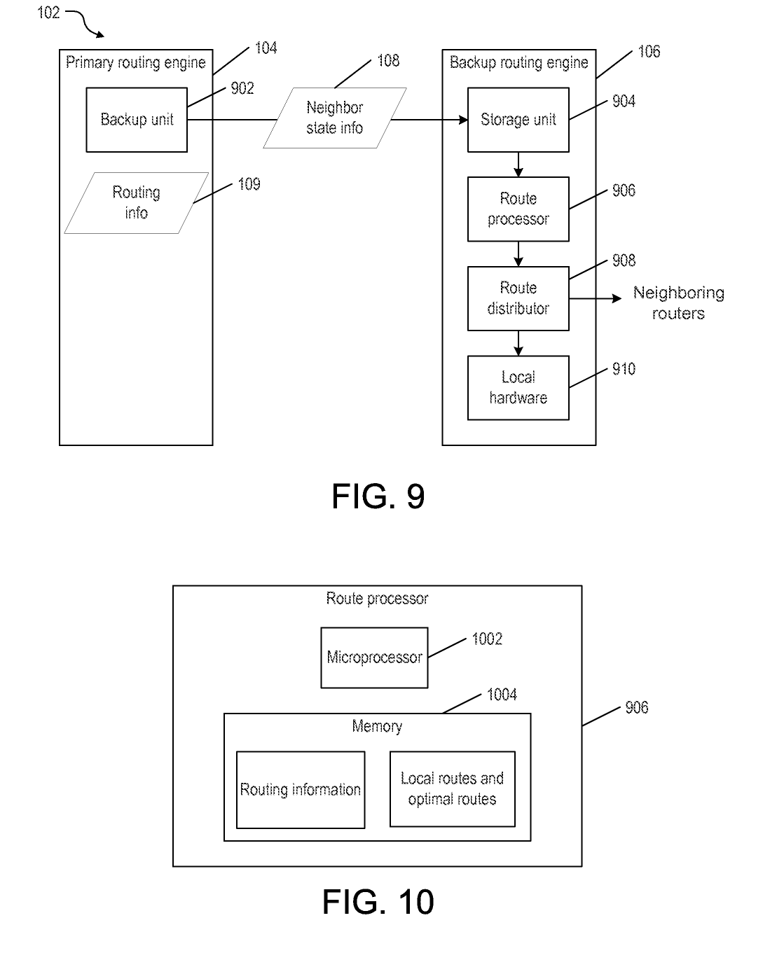

FIG. 9 is a block diagram of router 102 (FIG. 1) in one or more examples of the present disclosure. Router 102 includes primary routing engine 104 and backup routing engine 106. Primary routing engine 104 includes a backup unit 902 to back up neighbor state information 108 but not routing information 109 to backup routing engine 106 when the primary routing engine is operating normally. Backup routing engine 106 includes a storage unit 904 to receive and save neighbor state information 108. Backup routing engine 106 includes a route processor 906 to obtain routing information based on neighbor state information 108, determine local routes based on the routing information, and determine best routes based on the local routes. Depending on the routing protocol and network type, route processor 906 may operate according to one of methods 300, 400, 500, 600, 700, and 800 in FIGS. 3 to 8, respectively. Backup routing engine 106 includes a route distributor 908 to send the best routes to neighboring routers 110 and 112, and to save the best routes to local hardware 910.

When the routing protocol is BGP, route processor 906 obtains the routing information of the neighboring routers by sending a ROUTE-FRESH message to the neighboring routers 110 and 112 and receiving UPDATE messages with routing information of the neighboring routers from the neighboring routers.

When router 102 is a DIS in a broadcast network 100 (FIG. 1) using the IS-IS routing protocol, route processor 906 obtains routing information 109 of neighboring routers 110 and 112 by sending to a CSNP packet to the neighboring routers and receiving LSP packets from the neighboring routers.

When router 102 is not a DIS in a broadcast network 100 using the IS-IS routing protocol, route processor 906 obtains routing information 109 by receiving a CSNP packet from each DIS listed in neighbor state information 108, determining a missing routing information that does not exist in router 102 but is described in the summaries of routing information in the CSNP packets, sending to the DIS a PSNP packet carrying a summary of the missing routing information, and receiving a LSP packet from the DIS. The LSP packet carries the missing routing information.

When router 102 is in a point-to-point (P2P) network using the IS-IS routing protocol, route processor 906 obtains routing information 109 by sending a CSNP packet carrying a summary of routing information at the router to neighboring routers 110 and 112, and receiving

LSP packets from the neighboring routers. The LSP packet carries missing routing information that exists in the neighboring routers but is not described in the CSNP packet.

When the routing protocol is OSPF, route processor 906 obtains routing information 109 by sending a LSDB request packet to neighboring routers 110 and 112, and receiving LSU packets from the neighboring routers. The LSU packets carry the routing information at neighboring routers 110 and 112.

When the routing protocol is LDP, route processor 906 obtains routing information 109 by sending a label request packet that includes a wildcard for the FEC type to the neighboring routers 110 and 112, and receiving label mapping packets from the neighboring routers. The label mapping packets carry FEC and label mappings. Route processor 906 then generates a label mapping table based on the FEC and label mappings in the label mapping packets from neighboring devices 110 and 112.

Each component in router 102 may be implemented to perform its function in hardware or a combination of firmware and hardware. For example, each unit may be implemented with ASICs, FPGAs, or a microprocessor with nonvolatile memory. FIG. 10 shows route processor 906 implemented with a microprocessor 1002 with nonvolatile memory 1004 in one or more examples of the present disclosure.

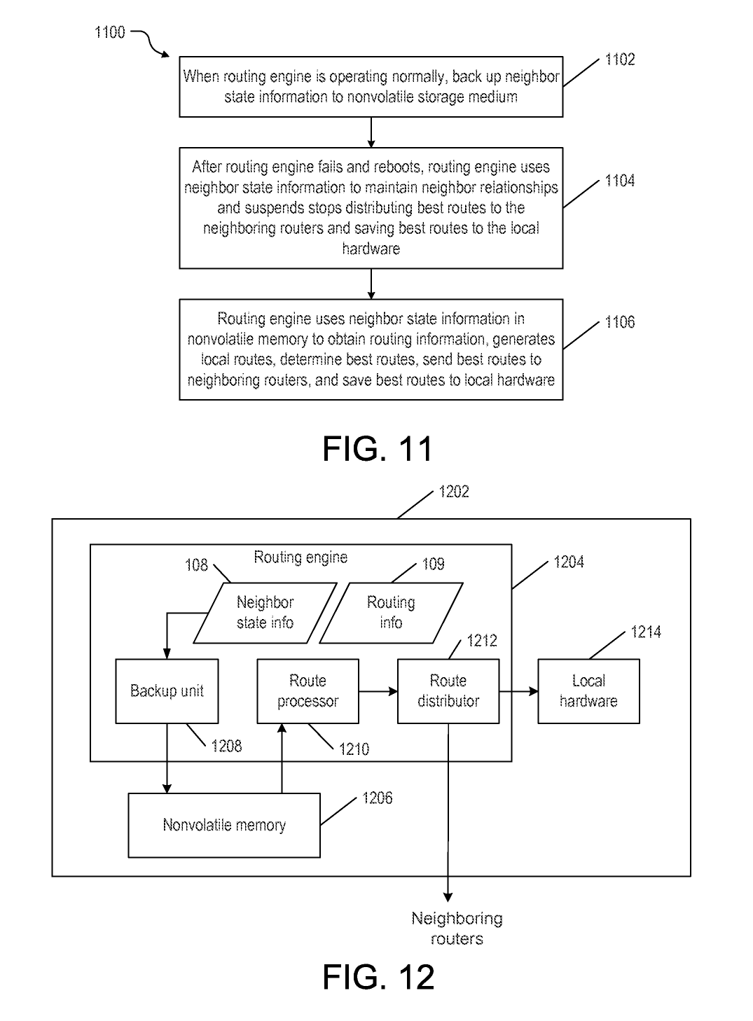

FIG. 11 is a flowchart of a method 1100 for a router 1202 (FIG. 12) to implement NSR of a routing protocol in one or more examples of the present disclosure. Unlike router 102 (FIGS. 1 and 9), router 1202 has a single routing engine 1204 (FIG. 12). Method 1100 may begin in block 1102.

In block 1102, when routing engine 1204 is operating normally, the routing engine backs up neighbor state information 108 (FIG. 12) but not routing information 109 (FIG. 12) to a nonvolatile memory 1206 (FIG. 12). Block 1102 may be followed by block 1104.

In block 1104, after routing engine 1204 reboots, the routing engine uses neighbor state information 108 saved in nonvolatile memory 1206 to maintain neighbor relationships to ensure neighbor connections of the routing protocol are not interrupted after the switchover. Routing engine 1204 also suspends distributing best routes to the neighboring routers and saving the best routes to the local hardware until the best routes are determined again. Block 1104 may be followed by block 1106.

In block 1106, routing engine 1204 obtains routing information 109 based on neighbor state information 108 saved in nonvolatile memory 1206. The reboot of routing engine 1204 may be unplanned, such as a result when the routing engine has a fault. Alternatively the reboot of routing engine 1204 may be planned, such as a result when the routing engine updates its firmware. Depending on the routing protocol and network type, routing engine 1204 of router 1202 may operate similarly as backup routing engine 106 of router 102 (FIGS. 1 and 9) in methods 300, 400, 500, 600, 700, and 800 in FIGS. 3 to 8, respectively, to obtain the routing information based on neighbor state information 108.

After obtaining routing information 109, routing engine 1204 determines local routes based on the routing information, determines best routes based on the local routes, sends the best routes to neighboring routers 110 and 112, and saves the best routes to local hardware.

FIG. 12 is a block diagram of router 1202 in one or more examples of the present disclosure. Router 1202 includes a single routing engine 1204 and nonvolatile memory 1206. In another example, nonvolatile memory 1206 may be remote and accessed over a network. Routing engine 1204 includes a backup unit 1208 to back up neighbor state information 108 but not routing information 109 to nonvolatile memory 1206 when the routing engine is operating normally. Routing engine 1204 includes a route processor 1210 to obtain routing information based on neighbor state information 108, determine local routes based on the routing information, and determine best routes based on the local routes. Depending on the routing protocol and network type, routing engine 1204 of router 1202 may operate similarly as backup routing engine 106 of router 102 (FIGS. 1 and 9) in methods 300, 400, 500, 600, 700, and 800 in FIGS. 3 to 8, respectively, to obtain the routing information based on neighbor state information 108. Routing engine 1204 includes a route distributor 1212 to sends the best routes to neighboring routers 110 and 112, and to save the best routes to local hardware 1214.

Like router 102, each component in router 1202 may be implemented to perform its function in hardware or a combination of firmware and hardware. For example, each unit may be implemented with ASICs, FPGAs, or a microprocessor with nonvolatile memory.

Various other adaptations and combinations of features of the examples disclosed are within the scope of the present disclosure.

What is claimed is:

1. A method for a router comprising a primary routing engine and a backup routing engine to implement non-stop routing of a routing protocol, the method comprises:
when the primary routing engine is operating normally, the primary routing engine backing up neighbor state information to the backup routing engine; and
when the backup routing engine takes over for the primary routing engine, the backup routing engine:
maintaining neighbor relationships based on the neighbor state information;
obtaining routing information based on the neighbor state information saved locally at the backup routing engine;
generating local routes based on the routing information;
determining best routes based on the local routes;
sending the best routes to neighboring routers; and
saving the best routes to local hardware.

2. The method of claim 1, further comprising, when the backup routing engine takes over for the primary routing engine and before the backup routing engine determines the best routes, the backup routing engine suspending sending any best route to the neighboring routers and saving any best route to the local hardware.

3. The method of claim 1, wherein:
the routing protocol is a Boarder Gateway Protocol (BGP); and
the backup routing engine obtaining routing information based on the neighbor state information saved locally at the backup routing engine comprises the backup routing engine sending to the neighboring routers a ROUTE-FRESH message and receiving from the neighboring routers UPDATE messages carrying their routing information.

4. The method of claim 1, wherein:
when the router is in a broadcast network using an Intermediate System-Intermediate System (IS-IS) routing protocol and the router is a Designated Intermediate System (DIS), the backup routing engine obtaining routing information based on the neighbor state information saved locally at the backup routing engine comprises the backup routing engine:
sending to a complete serial number protocol data unit (CSNP) packet the neighboring routers; and
receiving a link-state protocol data unit (LSP) packet from each neighboring router that has identified missing routing information that exists at the neighboring router but is not described in the CSNP packet, the LSP packet carrying the missing routing information;
when the router is in a broadcast network using an IS-IS routing protocol and the router is not a DIS, the backup routing engine obtaining routing information of the neighboring routers based on the neighbor state information saved locally at the backup routing engine comprises, for each DIS listed in the neighbor state information, the backup routing engine:
receiving a CSNP packet from the DIS;
determining missing routing information that does not exist at the router but is described in the CSNP packet;
sending to each DIS a partial serial number protocol data unit (PSNP) packet carrying a second summary of the missing routing information; and
receiving a LSP packet from the DIS, the LSP packet carrying the missing routing information; and
when the router is in a point-to-point (P2P) network using an IS-IS routing protocol and the backup routing engine obtaining routing information based on the neighbor state information saved locally at the backup routing engine comprises the backup routing engine:
sending a CSNP packet to the neighboring routers; and
receiving a LSP packet from each neighboring router that has identified missing routing information that exists at the neighboring router but is not described in the CSNP packet, the LSP packet carrying the missing routing information.

5. The method of claim 1, wherein:
when the routing protocol is an Open Shortest Path First (OSPF) routing protocol and the backup routing engine obtaining routing information based on the neighbor state information saved locally at the backup routing engine comprising the backup routing engine:
sending a Link State Data Base (LSDB) request packet to the neighboring routers; and
receiving from the neighboring routers link state update (LSU) packets carrying routing information in their LSDBs; and
when the router is in a Multi-Protocol Label Switching (MPLS) network using a label distribution protocol (LDP) and the backup routing engine obtaining routing information based on the neighbor state information saved locally at the backup routing engine comprises the backup routing engine:
sending a label request packet to the neighboring routers, the label request packet includes a wildcard for a Forwarding Equivalence Class (FEC) type;
receiving label mapping packets from the neighboring routers carrying FEC and label mappings; and
generating a label mapping table based on the label mappings.

6. A method for a router having a single routing engine to implement non-stop routing of a routing protocol, the method comprises:
when the routing engine is operating normally, saving neighbor state information into a nonvolatile memory; and
after the routing engine reboots:
maintaining neighbor relationships based on the neighbor state information;
obtaining routing information based on the neighbor state information saved in the nonvolatile memory;
generating local routes based on the routing information;
determining best routes based on the local routes;
sending the best routes to neighboring routers, and
saving the best routes to local hardware.

7. The method of claim 6, further comprising, after the routing engine reboots and before the routing engine determines the best routes, the routing engine suspending sending any best route to the neighboring routers and saving any best route to the local hardware.

8. The method of claim 6, wherein:
the routing protocol is a Boarder Gateway Protocol (BGP); and
the routing engine obtaining routing information based on the neighbor state information saved in the nonvolatile memory comprises the routing engine sending to the neighboring routers a ROUTE-FRESH message and receiving from the neighboring routers UPDATE messages carrying their routing information.

9. The method of claim 6, wherein:
when the router is in a broadcast network using an Intermediate System-Intermediate System (IS-IS) routing protocol and the router is a Designated Intermediate System (DIS), the routing engine obtaining routing information based on the neighbor state information saved in the nonvolatile memory comprises the routing engine:
sending to a complete serial number protocol data unit (CSNP) packet the neighboring routers; and
receiving a link-state protocol data unit (LSP) packet from each neighboring router that has identified missing routing information that exists at the neighboring router but is not described in the CSNP packet, the LSP packet carrying the missing routing information;
when the router is in a broadcast network using an IS-IS routing protocol and the router is not a DIS, the routing engine obtaining routing information of the neighboring routers based on the neighbor state information saved locally at the backup routing engine comprises, for each DIS listed in the neighbor state information, the routing engine:
receiving a CSNP packet from the DIS;
determining missing routing information that does not exist at the router but is described in the CSNP packet;
sending to each DIS a partial serial number protocol data unit (PSNP) packet carrying a second summary of the missing routing information; and
receiving a LSP packet from the DIS, the LSP packet carrying the missing routing information; and
when the router is in a point-to-point (P2P) network using an IS-IS routing protocol and the routing engine obtaining routing information based on the neighbor state information saved in the nonvolatile memory comprises the routing engine:
sending a CSNP packet to the neighboring routers; and
receiving a LSP packet from each neighboring router that has identified missing routing information that exists at the neighboring router but is not described in the CSNP packet, the LSP packet carrying the missing routing information.

10. The method of claim 6, wherein:
when the routing protocol is an Open Shortest Path First (OSPF) routing protocol and the routing engine obtaining routing information based on the neighbor state information saved in the nonvolatile memory comprises the routing engine:
sending a Link State Data Base (LSDB) request packet to the neighboring routers; and
receiving from the neighboring routers link state update (LSU) packets carrying routing information in their LSDBs; and
when the router is in a Multi-Protocol Label Switching (MPLS) network using a label distribution protocol (LDP) and the routing engine obtaining routing information based on the neighbor state information saved in the nonvolatile memory comprises the routing engine:
sending a label request packet to the neighboring routers, the label request packet includes a wildcard for a Forwarding Equivalence Class (FEC) type;
receiving label mapping packets from the neighboring routers carrying FEC and label mappings; and
generating a label mapping table based on the label mappings.

11. An apparatus to implement non-stop routing of a routing protocol, comprising:
a primary routing engine comprising a backup unit to back up neighbor state information to a backup routing engine when the primary routing engine is operating normally;
the backup routing engine, comprising:
a storage unit to save the neighbor state information from the backup unit;
a route processor to, when the backup routing engine takes over for the primary routing engine, maintain neighbor relationships based on the neighbor state information, obtain routing information based on the neighbor state information saved in the storage unit, generate local routes based on the routing information, and determine best routes based on the local routes; and
a route distributer to send the best routes to neighboring routers and to save the best routes to local hardware.

12. The apparatus of claim 11, wherein the route processor is configured to, when the backup routing engine takes over for the primary routing engine, suspend sending any best route to the neighboring routers and saving any best route to the local hardware.

13. The apparatus of claim 11, wherein:
when the routing protocol is a Boarder Gateway Protocol, the route processor is to obtain routing information based on the neighbor state information saved in the storage unit by sending to the neighboring routers a ROUTE-FRESH message and receiving from the neighboring routers UPDATE messages carrying their routing information;
when the router is a Designated Intermediate System (DIS) in a broadcast network using an Intermediate System-Intermediate System (IS-IS) routing protocol, the route processor is to obtain routing information based on the neighbor state information saved in the storage unit by:
sending to a complete serial number protocol data unit (CSNP) packet the neighboring routers; and
receiving a link-state protocol data unit (LSP) packet from each neighboring router that has identified missing routing information that exists at the neighboring router but is not described in the CSNP packet, the LSP packet carrying the missing routing information;
when the router is not a DIS in a broadcast network using an IS-IS routing protocol, the backup routing engine obtaining routing information of the neighboring routers based on the neighbor state information saved locally at the backup routing engine comprises, for each DIS listed in the neighbor state information, the backup routing engine:
receiving a CSNP packet from the DIS;
determining missing routing information that does not exist at the router but is described in the CSNP packet;
sending to each DIS a partial serial number protocol data unit (PSNP) packet carrying a second summary of the missing routing information; and
receiving a LSP packet from the DIS, the LSP packet carrying the missing routing information;
when the router is in a point-to-point (P2P) network using an IS-IS routing protocol, the route processor obtains routing information based on the neighbor state information saved in the storage unit by:
sending a CSNP packet to the neighboring routers; and
receiving a LSP packet from each neighboring router that has identified missing routing information that exists at the neighboring router but is not described in the CSNP packet, the LSP packet carrying the missing routing information;
when the routing protocol is an Open Shortest Path First (OSPF) routing protocol, the route processor obtains routing information based on the neighbor state information saved in the storage unit by:
sending a Link State Data Base (LSDB) request packet to the neighboring routers; and
receiving from the neighboring routers link state update (LSU) packets carrying routing information in their LSDBs; and
when the router is in a Multi-Protocol Label Switching (MPLS) network using a label distribution protocol (LDP), the route processor obtains routing information based on the neighbor state information saved in the storage unit by:
sending a label request packet to the neighboring routers, the label request packet includes a wildcard for a Forwarding Equivalence Class (FEC) type;
receiving label mapping packets from the neighboring routers carrying FEC and label mappings; and
generating a label mapping table based on the label mappings.

14. An apparatus to implement non-stop routing of a routing protocol, comprising:
a single routing engine, comprising:
a backup unit to save neighbor state information into nonvolatile memory when the routing engine is operating normally;
a route processor to, after the routing engine reboots, maintain neighbor relationships based on the neighbor state information, obtain routing information based on the neighbor state information saved in the nonvolatile memory, generate local routes based on the routing information, and determining best routes based on the local routes; and
a routing distributer to send the best routes to neighboring routers and save the best routes to local hardware.

15. The apparatus of claim 14, wherein the route processor is configured to, after the routing engine reboots and before the route processor obtains the routing information based on the neighbor state information saved in the nonvolatile memory, suspend sending any best route to the neighboring routers and saving any best route to the local hardware.

16. The apparatus of claim 14, wherein:
when the routing protocol is a Boarder Gateway Protocol, the route processor obtains routing information based on the neighbor state information saved in the nonvolatile memory by sending to the neighboring routers a ROUTE-FRESH message and receiving from the neighboring routers UPDATE messages carrying their routing information;
when the router is a Designated Intermediate System (DIS) in a broadcast network using an Intermediate System-Intermediate System (IS-IS) routing protocol, the route processor obtains routing information based on the neighbor state information saved in the nonvolatile memory by:
sending to a complete serial number protocol data unit (CSNP) packet the neighboring routers; and
receiving a link-state protocol data unit (LSP) packet from each neighboring router that has identified missing routing information that exists at the neighboring router but is not described in the CSNP packet, the LSP packet carrying the missing routing information;
when the router is not a DIS in a broadcast network using an IS-IS routing protocol, the routing engine obtaining routing information of the neighboring routers based on the neighbor state information saved locally at the backup routing engine comprises, for each DIS listed in the neighbor state information, the routing engine:
receiving a CSNP packet from the DIS;
determining missing routing information that does not exist at the router but is described in the CSNP packet;
sending to each DIS a partial serial number protocol data unit (PSNP) packet carrying a second summary of the missing routing information; and
receiving a LSP packet from the DIS, the LSP packet carrying the missing routing information;
when the router is in a point-to-point (P2P) network using an IS-IS routing protocol, the route processor obtains routing information based on the neighbor state information saved in the nonvolatile memory by:
sending a CSNP packet to the neighboring routers; and
receiving a LSP packet from each neighboring router that has identified missing routing information that exists at the neighboring router but is not described in the CSNP packet, the LSP packet carrying the missing routing information;
when the routing protocol is an Open Shortest Path First (OSPF) routing protocol, the route processor obtains routing information based on the neighbor state information saved in the nonvolatile memory by:
sending a Link State Data Base (LSDB) request packet to the neighboring routers; and
receiving from the neighboring routers link state update (LSU) packets carrying routing information in their LSDBs; and
when the router is in a Multi-Protocol Label Switching (MPLS) network using a label distribution protocol (LDP), the route processor obtains routing information based on the neighbor state information saved in the nonvolatile memory by:
sending a label request packet to the neighboring routers, the label request packet includes a wildcard for a Forwarding Equivalence Class (FEC) type;
receiving label mapping packets from the neighboring routers carrying FEC and label mappings; and
generating a label mapping table based on the label mappings.
